(19) United States
(12) Patent Application Publication
(10) Pub. No.: US 2024/0092247 A1
(43) Pub. Date: Mar. 21, 2024

(54) RESTRAINING DEVICE

(71) Applicant: Julien Macameau, St-Etienne-de-Lauzon (CA)

(72) Inventor: Julien Macameau, St-Etienne-de-Lauzon (CA)

(21) Appl. No.: 17/947,528

(22) Filed: Sep. 19, 2022

(30) Foreign Application Priority Data
Sep. 24, 2021 (GB) 2113705.4

(51) Int. Cl. B60P 7/08; E21D 19/00

(52) U.S. Cl. CPC B60P 7/0876; E21D 19/00

(57) ABSTRACT

A restraining device securable to anchors, the restraining device comprising: a flexible net defining a net peripheral edge; a peripheral cable secured to the net at the net peripheral edge; and a plurality of attachments for anchoring the peripheral cable to the anchors.

### FIELD OF THE INVENTION

The present invention relates to the general field of safety equipment and, more particularly, to a restraining device.

### BACKGROUND

There is often a need to secure cargo elements loaded on a truck or trailer flatbed. In some instances, this is done by using several elongated tie-down straps or chain links extending transversally in a parallelly spaced apart relationship on top of the cargo elements, and attached and tightened to flatbed anchor points provided along the longitudinal side edges thereof. These straps are generally sufficient for securing cargo on a truck or trailer flatbed such that cargo elements do not fall off the flatbed by themselves during transport. However, these straps have shown to fail to sufficiently secure cargo elements represented by uniformly elongated members stacked and secured parallelly longitudinally together on a flatbed.

Indeed, this type of cargo elements, such as for example, elongated telephone poles, steel rolls, lumber, planks, H-beams, and the likes, remain at risk of slipping forwardly and crash into the back of the driver cabin when the transport truck experiences an abrupt braking or frontal impact event, even though the cargo elements are tightly tied down to the flatbed. Such events can cause grave body injuries to the occupant(s) of the driver cabin and, in some cases, provoke further cascading road accidents due to a wounded driver of the truck and/or the spread of cargo elements on the road surface.

Thus, there is a need on the market for an improved devices that avoids the aforementioned disadvantages. An object of the present invention is therefore to provides such an improved device.

### SUMMARY OF THE INVENTION

In a broad aspect, there is provided a restraining device securable to anchors, the restraining device comprising: a flexible net defining a net peripheral edge; a peripheral cable secured to the net at the net peripheral edge; and a plurality of attachments for anchoring the peripheral cable to the anchors.

There may also be provided a restraining device wherein the peripheral cable is woven through the net at the net peripheral edge.

There may also be provided a restraining device wherein the net includes a plurality of annular elements intersecting each other to form a mesh.

There may also be provided a restraining device wherein the attachments are formed by loops defined in the peripheral cable and closed by at least one clamp so that the loops protrude from the net.

There may also be provided a restraining device wherein the at least one clamp is configured to slip relative to the peripheral cable when a predetermined load on the loop is reached to absorb shocks exerted on the restraining device.

There may also be provided a restraining device wherein the at least one clamp include at least two clamps each configured to slip relative to the peripheral cable when a respective predetermined load on the loop is reached, the predetermined loads associated with each clamp differing from each other, an outer clamp from the at least two clamps provided closer to a free end of the loop than an inner clamp from the at least two clamps slipping under larger loads than the inner clamp.

There may also be provided a restraining device further comprising a resiliently deformable element between the at least two clamps.

There may also be provided a restraining device further comprising a bushing between the at least one clamp and the peripheral cable.

There may also be provided a restraining device further comprising a movement limiter to limit a range of motion of the at least one clamp along the peripheral cable.

There may also be provided a restraining device wherein the movement limiter includes a ring encircling the at least one clamp and extending both through the loop and through a portion of the net adjacent the loop.

There may also be provided a restraining device further comprising a plurality of elongated cargo tie-downs each defining opposed proximal and distal ends, each cargo tie-down being secured to a respective one the attachments at its proximal end, and each cargo tie-down being securable to a respective one of the anchors at its distal end.

There may also be provided a restraining device further comprising at least one reinforcement cable extending across the net between spaced apart locations on the peripheral cable.

There may also be provided a restraining device wherein the at least one clamp include at least two clamps each configured to slip relative to the peripheral cable when a respective predetermined load on the loop is reached, the predetermined loads associated with each clamp differing from each other.

There may also be provided a restraining device, further comprising a coupling element mechanically coupling the net and the clamps so that pulling on the net while the loops are anchored results in the net pulling the clamps away from the anchor through the coupling element.

There may also be provided a restraining device wherein the coupling element includes a closed loop encircling the at least one clamp and extending through a portion of the net adjacent the loop.

There may also be provided a restraining device wherein the coupling element includes at least two closed loops each encircling the at least one clamp and each extending through a respective portion of the net adjacent the loop.

There may also be provided a restraining device wherein the at least one clamp includes at least two clamps, an outer clamp from the at least two clamps provided closer to a free end of the loop than an inner clamp from the at least two clamps slipping under smaller loads than the inner clamp.

In another broad aspect, there is provided a method of using the restraining devices mentioned above, the method comprising fitting the net around a front portion of a cargo carried by a flatbed trailer or truck so that the peripheral cable is positioned around the cargo behind a frontwardmost portion of the cargo; and securing the attachments to the anchors, the anchors being provided on the flatbed trailer or truck behind the net.

There may also be provided a method wherein securing the attachments to the anchors includes providing cargo tie-downs between the attachments and the anchors.

There may also be provided a method further comprising applying a tension in the cargo tie-downs.

In another broad aspect, there is provided a method of using the restraining devices mentioned above, the method comprising: anchoring anchors in a wall or ceiling of a mine; fitting the net adjacent the wall or ceiling; and securing the attachments to the anchors.

There may also be provided a method wherein the net is secured to the ceiling of the mine.

Advantageously, the proposed device may efficiently restrain relatively heavy cargo and other items under relatively large forces at a relatively small cost.

Also, the proposed device may in some embodiments be installed and removed relatively quickly using a small number or short steps.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates an embodiment of a restraining device, according to the present invention, here shown mounted on the front end of a cargo loaded on a flatbed trailer;

FIG. 2, in a plan view, illustrates an embodiment of a link element part of the restraining device of FIG. 1;

FIG. 3, in a plan view, illustrates an alternative embodiment of a link element usable in the device of FIG. 1;

FIG. 4, in a cutaway view, illustrates a corner of the device of FIG. 1;

FIG. 5, in a plan view, illustrates the cargo restraining device of FIG. 1, here shown having a square configuration;

FIG. 6, in a plan view, illustrates an alternative embodiment of a restraining device, here shown having a rectangular configuration;

FIG. 7, in a plan view, illustrates another alternative embodiment of a restraining device, here shown having a circular configuration;

FIG. 8, in a perspective view, illustrates the restraining device of FIG. 1 used to protect miners in a mine from falling debris;

FIG. 9, in a perspective view, illustrates an embodiment of an attachment usable in the restraining device of FIG. 1;

FIG. 10, in a perspective view, illustrates another embodiment of an attachment usable in the restraining device of FIG. 1;

FIG. 11, in a perspective view, illustrates yet another embodiment of an attachment usable in the restraining device of FIG. 1;

FIG. 12, in a perspective view, illustrates yet another embodiment of an attachment usable in the restraining device of FIG. 1;

FIG. 13, in a perspective view, illustrates yet another embodiment of an attachment usable in the restraining device of FIG. 1.

### DETAILED DESCRIPTION

The terms “substantially” and “about” are used throughout this document to indicate variations in the thus qualified terms. These variations are variations that do not materially affect the manner in which the invention works and can be due, for example, to uncertainty in manufacturing processes or to small deviations from a nominal value or ideal shape that do not cause significant changes to the invention.

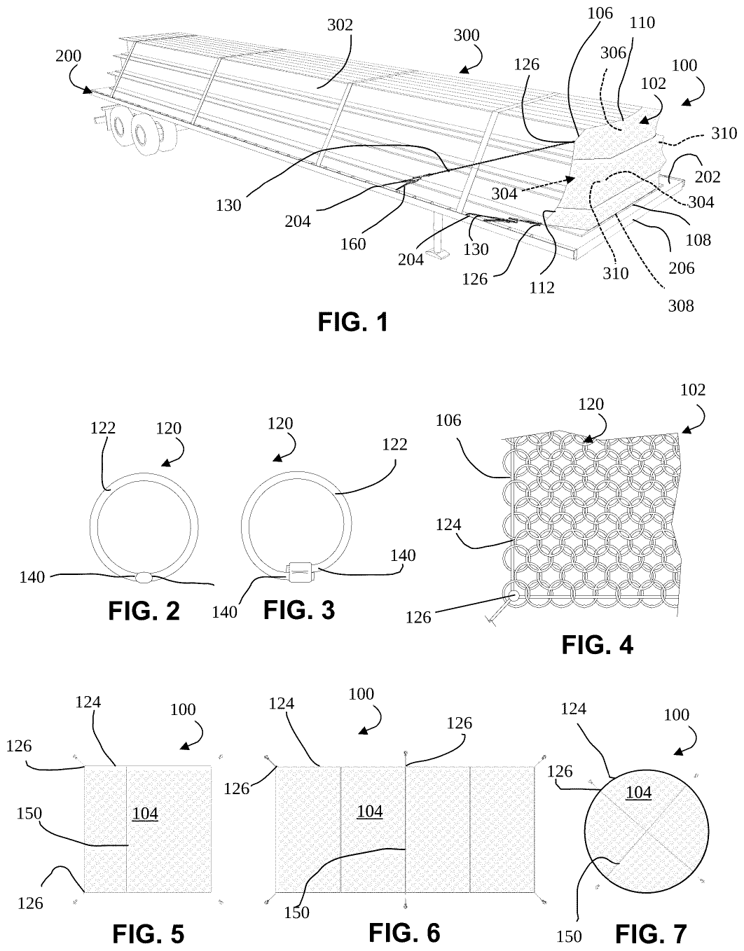

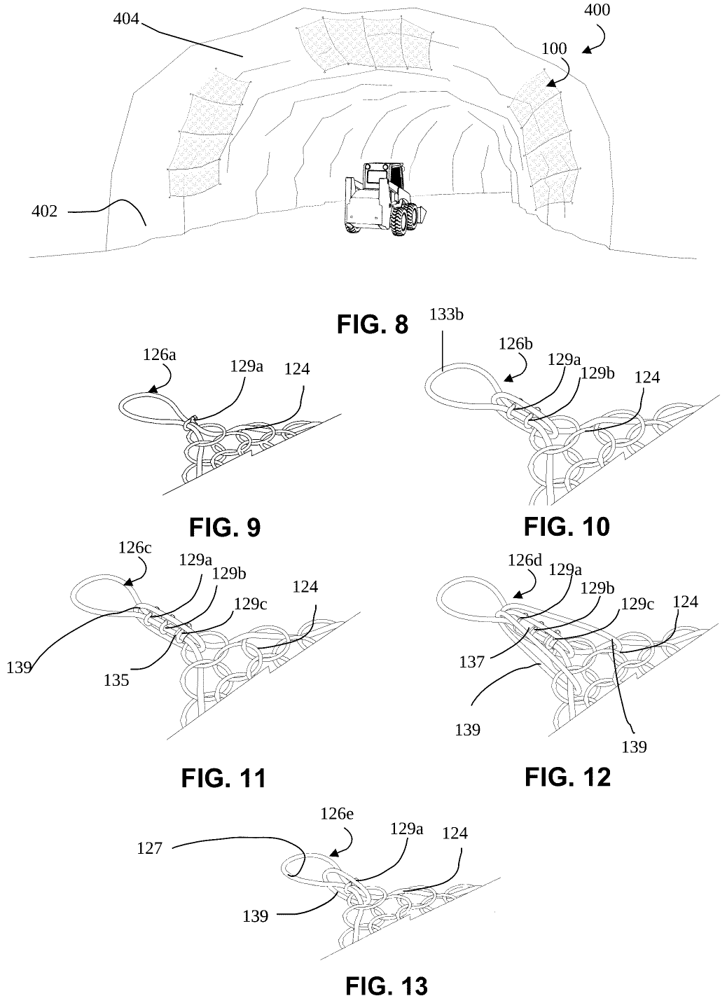

FIGS. 1 to 8, illustrates various aspects of an embodiment of a restraining device 100, also called a cargo restraining device when used to restrain cargo. The restraining device is however usable in many other applications, such as to protect miners 400 from falling debris from a wall 402 or ceiling 404 of a mine 400, as seen in FIG. 8, or to line aging infrastructures to catch detached concrete pieces, among other uses. In the example shown in FIG. 1, the cargo restraining device 100 is usable for restraining the front end 304 of a cargo 300 resting on a flat surface portion 202 of a truck or trailer flatbed 200.

According to an embodiment of the present invention, the cargo 300 has a front end 304 defined by substantially transversally extending cargo front upper and lower edges 306 and 308, and a pair of substantially vertically extending cargo front side edges 310.

The truck or trailer flatbed 200 is equipped with flatbed anchor points 204 along side edges thereof acting as anchors to which the cargo protection device 100 can be secured.

Referring, for example, to FIG. 5, the cargo restraining device 100 includes a flexible net 102. The flexible net 102 includes a net body 104, and a net peripheral edge 106 surrounding the net body 104.

The net peripheral edge 106 includes a net peripheral edge bottom portion 108, a net peripheral edge top portion 110, and net peripheral edge opposed side portions 112.

Referring back to FIG. 1, the flexible net 102 is sufficiently dimensioned for covering at least the front end 304 of the cargo 300 such that the net peripheral edge bottom portion 108 extends substantially adjacently parallelly the cargo front lower edge 308 in contact with the flat surface portion 202.

Furthermore, the net peripheral edge top portion 110 extends substantially adjacently parallelly the cargo front upper edge 306. Still furthermore, the net peripheral edge opposed side portions 112 each extends substantially adjacently parallelly the opposed cargo front side edges 310. This results in a configuration wherein the flexible net 102 is fitted around front end 304 of the cargo 300 so that the net peripheral edge 106 is positioned around the cargo 300, behind a frontwardmost portion of the cargo 300.

Referring to FIG. 4, the flexible net 102 is formed of a multitude of annular link elements 120 intersecting each other. For example, and non-limitingly, annular the link elements 120 are arranged on a hexagonal grid configuration, so that each annular link element 120 that is away from the net peripheral edge 106 engages its 6 neighbors. In other embodiments, the annular the link elements 120 are arranged on a square grid configuration,

Referring to FIG. 2, each annular link element 120 includes a substantially elongated and tear resistant link member 122 having its opposed longitudinal ends 140 rigidly joined to one another to form a closed loop. As seen in FIG. 4, each closed loop has a portion thereof extending through each immediately adjacent closed loop, thus forming the flexible net 102.

Referring now more particularly to FIG. 4, the cargo restraining device 100 further comprises a peripheral cable 124 secured to the net 102, typically woven through the link elements 120 at the net peripheral edge 106. The peripheral cable 124 may be made of a continuous piece of material or of many pieces of material secured to each other. Typically, the peripheral cable 124 may be woven through the outermost link elements 120 of the net 102, but in other embodiments, is woven slightly inwardly relative thereto.

Referring to FIG. 1, the cargo restraining device 100 further comprises at least three, typically between three and twenty, peripheral attachments 126. The attachments 126 are connected in a spaced apart relationship along the peripheral cable 124, and are suitably sized and configured for connecting thereto a cargo tie-down 130, or to secure the cargo restraining device 100 to anchors in any suitable manner. For example, the attachments take the form of beads through which the peripheral cable 124 extend and to which the cargo tie-downs 130 are secured. The opposite end of the cargo tie-downs are for example secured to an adjacent flatbed anchor point 204. In some embodiments, the flatbed anchor points 204 are provided behind the net 102.

The cargo restraining device 100 is usable with at least a first pair of cargo tie-downs 130. Each cargo tie-down 130 in the pair having a first end connected to a respective attachment 126 located proximally a respective end of the net peripheral edge bottom portion 108, and a second end connected and tightened to an adjacent flatbed anchor point 204 located at least slightly rearwardly of the respective attachment 126.

There is further at least a second pair of cargo tie-downs 130 having each a first end connected to a attachment 126 located proximally a respective end of the net peripheral edge top portion 110, and a second end connected and tightened to an adjacent flatbed anchor point 204 located at least slightly rearwardly of the respective attachment 126.

Thus, cargo elements 302 are prevented from violently sliding forwardly relative to the truck or trailer flatbed 200 and crash into the back of the driver cabin when the transport truck experiences an abrupt braking of frontal impact event.

The cargo restraining device 100 of the present invention is particularly useful for restraining elongated and regular shaped cargo elements 302 loaded parallelly longitudinally relative to the truck or trailer flatbed 200. For example, elongated telephone poles, lumber, planks, H-beams (as exemplified in FIG. 1), and the likes. This type of cargo elements 302 are typically at risk of slipping forwardly when the transport truck experiences an abrupt braking or frontal impact event, even though they are tightly tied down to the flatbed 200 with multiple tie-downs 130 extending transversally relative thereof. Typically, as illustrated in FIG. 1, the cargo restraining device 100 is used for restraining a cargo 300 having its cargo front end 304 extending adjacent, the front edge 206 of the truck or trailer flatbed 200.

As is often the case, the cargo front end 304 overlaps the front edge 206 of the truck or trailer flatbed 200. In such case, additional cargo tie-downs 130 may be installed between the attachments 126 along the net peripheral edge bottom portion 108, and the front edge 206 of the truck or trailer flatbed 200, for providing additional restraining force to the cargo restraining device 100.

It is to be understood, that the cargo restraining device 100 may be used for restraining a cargo 300 having its front end 304 positioned at any longitudinal location along the truck or trailer flatbed 200.

Typically, as illustrated in FIG. 1, the flexible net 102 is dimensioned such that the net peripheral edge top portion 110 and net peripheral edge opposed side portions 112 at least slightly overlap rearwardly relative to the cargo front upper edge 306 and side edges 310 respectively, such that the flexible net 102 forms mask-like configuration covering at least slightly more than the cargo front end 304.

Thus, front end portions of individual cargo elements 302 are prevented from slipping sideways from the flexible net 102 and out of the truck or trailer flatbed 200 during an abrupt braking or front impact event of the transport truck.

The net peripheral edge 106 has a predetermined peripheral edge configuration defining for example one of a substantially square (seen in FIG. 5), rectangular (seen in FIG. 6), triangular (not shown in the drawings) or circular (seen in FIG. 7) configuration.

In some embodiments, the net peripheral edge 106 has a substantially square configuration and includes an attachment 126 at each corner thereof, and between one and three attachments 126 at equidistantly spaced apart locations between each adjacent corners. For example, the square configuration of the flexible net 102 may have a dimension of roughly 8′×8′. Other dimension values for the flexible net 102 are also possible.

Each link member 122 and the peripheral cable 124 are made of a suitably sturdy material, such as one of metal, plastic or Nylon™ wire. For example, each link member 122 and the peripheral cable 124 are made of flexible stainless steel wire rope. The opposed longitudinal ends 140 of the flexible stainless steel wire rope of each link member 122 are either soldered to one another (seen in FIG. 2), crimped to one another (seen in FIG. 3), or both soldered and crimped to one another. Each annular link element 120 has one of a substantially circular, square, hexagonal or octagonal peripheral configuration, among others. For example, as shown in the drawings, each annular link element 120 has a substantially circular peripheral configuration.

The flexible stainless steel wire rope has for example a diameter of between ⅛ and one inch. For example, the flexible stainless steel wire rope has a diameter of roughly ¼ inch. Also, each annular link element 120, or closed loop, has an outer diameter of between roughly four and six inches (about 10 cm), but it is to be understood that the outer diameter of each annular link element 120 may have other values such as, for example, 2, 3, 5, 6, 8 or 10 inches. It is also contemplated that the flexible net 102 may be represented by a suitable assembly of link elements 120 having at least two, for example between two and five differently dimensioned outer diameters. It is also to be understood that, in some embodiments of the invention, each annular link element 120 may be made of a rigid steel wire loop similar to a conventional metal chain link.

As exemplified in FIGS. 5, 6 and 7, in some embodiments of the invention, the cargo restraining device 100 further comprises between one and five intermediate cross cables 150 extending in a parallelly spaced apart relationship between at least two diametrically opposed portions of the peripheral cable 124 relative to the flexible net 102, wherein each intermediate cross cable 150 is weaved through the link elements 120 in a similar fashion as the peripheral cable 124. The intermediate cross cables 150 act as reinforcement cables. Typically, each intermediate cross cable 150 is made of the same material as the peripheral cable 124.

In some embodiments of the invention, the cargo restraining device 100 further comprises a plurality of substantially elongated tie-down 130 in corresponding number relative to the attachments 126. Each tie-down 130 has a tie-down proximal end removably or permanently connected to a user selected one of the attachments 126 and a tie-down distal end removably or permanently connected to a user selected flatbed anchor points 204 along side edges of the truck or trailer flatbed 200.

As exemplified in FIG. 1, each tie-down 130 may include one of of the following configuration: a tie-down binder 160 sized and configured for allowing a user to raise the tension in the tie-down 130, once the tie-down binder 160 is connected between the peripheral cable 124 and the anchor point 204, and/or a coil spring (not shown in the figures) sized and configured for allowing a user to pull and connect by hand the tie-down second end to the selected anchor point 204 of the truck or trailer flatbed 200.

FIGS. 9 to 13 illustrate alternatives to the attachments 126, respectively attachments 126a, 126b, 126c, 126d and 126e. The attachments 126a, 126b, 126c, 126d and 126e are formed by loops defined in the peripheral cable 124 and closed by at least one clamp 129a, 129b, 129c so that the attachments 126a, 126b, 126c, 126d and 126e protrude from the net 102. When many clamps 129a, 129b, 129c are provided they are typically spaced apart from each other along the peripheral cable 124 and all clamp the peripheral cable 124 at two spaced apart locations to form the loops of the attachments 126a, 126b, 126c, 126d and 126e.

Referring to FIG. 9, in a first embodiment, the attachment 126a includes a loop formed in the peripheral cable 124 and closed by one clamp 129a crimped or otherwise secured to the peripheral cable 124. In some embodiments, the clamp 129a is a two-piece clamps with the two pieces thereof secured to each other with fasteners, such as nuts. Varying the torque applied on the fastener varies the gripping force exerted by the clamp 129 on the peripheral cable 124. The clamp 129a is configured to slip relative to the peripheral cable 124 when a predetermined load is exerted on the attachment 126a. Indeed, if a large force is exerted on the net 102, which is transmitted to the peripheral cable 124. If the force is large enough, the clamp 129a will slip, which helps in absorbing shocks exerted on the restraining device 100, and therefore decreases the chances that the peripheral cable 124 will break due to a large force exerted thereonto.

In some embodiments, as seen in FIG. 13, a coupling element 139 mechanically coupling the net 102 and the clamp 129a is provided so that pulling on the net 102, and more particularly the net body 104, while the attachments 126e are anchored results in the net 102 pulling the clamp 129a away from the anchor through the coupling element 139 as the net body 102 moves along the peripheral cable 124. For example, the coupling element 139 takes the form of a closed loop encircling the clamp 129a and extending both through a loop 127 formed in the peripheral cable 124 to create the attachment 126e and through a portion of the net body 104 adjacent the loop 127. The coupling element 139 is made of a relatively strong material, similar for example to the material used to manufacture the net body 104 or the peripheral cable 124. In use, when a relatively large force is exerted on the net 102, the latter will pull on the coupling elements 139, which will in turn pull on the clamp 129a. Since the latter frictionally engages the peripheral cable 124, this friction will dissipate some of the energy that is fed into the net to act as a shock absorber. The coupling element may take the form of any other relatively rigid element coupling the clamp 129a and the net 102 to each other.

In the embodiment shown in FIG. 10, which also includes the coupling element 139, outer and inner clamps 129a and 129b are provided serially to close the loop of the attachment 126b. The outer clamp 129a is provided closer to a free end 133b of the attachment 126b than the inner clamp 129b. The clamps 129a and 129b are both configured to slip relative to the peripheral cable 124 when a respective predetermined load on the loop attachment 126b is reached. The predetermined loads associated with the outer and inner clamps 129a and 129b differs from each other. The outer clamp 129b slips under larger loads than the outer clamp 129a, which provides a 2 tier, or 2 steps dampening or shock absorption.

In the embodiment shown in FIG. 11, three clamps 129a, 129b and 129c are provided serially along the peripheral cable 124. A bushing 135 is provided between the innermost clamp 129c and the peripheral cable 124, for example a Teflon™ bushing 135. The configuration facilitates slipping of the innermost clamp 129c along the peripheral cable 124 to prevent the clamps 129a, 129b and 129c from digging into the peripheral cable 124 and damaging the latter when large forces are exerted on the attachment 126c.

As seen in FIG. 12, a resiliently deformable element 137, such as a rubber tube for example, may also be provided between two of the clamps 129a and 129b to absorb shocks as the clamps 129a and 129b push against each other due to different predetermined loads causing slippage. Also, more than one coupling element 139 may be provided, for example and non-limitingly, three coupling elements 139, each anchoring in a different portion of the net body 104 to distribute the loads transmitted through the coupling elements 139.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. A restraining device securable to anchors, the restraining device comprising:
a flexible net defining a net peripheral edge;
a peripheral cable secured to the net at the net peripheral edge; and
a plurality of attachments for anchoring the peripheral cable to the anchors.

2. The restraining device as defined in claim 1, wherein the peripheral cable is woven through the net at the net peripheral edge.

3. The restraining device as defined in claim 1, wherein the net includes a plurality of annular elements intersecting each other to form a mesh.

4. The restraining device as defined in claim 1, wherein the attachments are formed by loops defined in the peripheral cable and closed by at least one clamp so that the loops protrude from the net.

5. The restraining device as defined in claim 4, wherein the at least one clamp is configured to slip relative to the peripheral cable when a predetermined load is reached on the net to absorb shocks exerted on the restraining device.

6. The restraining device as defined in claim 4, wherein the at least one clamp include at least two clamps each configured to slip relative to the peripheral cable when a respective predetermined load on the loop is reached, the predetermined loads associated with each clamp differing from each other.

7. The restraining device as defined in claim 6, further comprising a resiliently deformable element between the at least two clamps.

8. The restraining device as defined in claim 4, further comprising a bushing between the at least one clamp and the peripheral cable.

9. The restraining device as defined in claim 4, further comprising a coupling element mechanically coupling the net and the at least one clamp to each other so that pulling on the net while the loops are anchored results in the net pulling the clamps away from the anchor through the coupling element.

10. The restraining device as defined in claim 9, wherein the coupling element includes a closed loop encircling the at least one clamp and extending through a portion of the net adjacent the loop.

11. The restraining device as defined in claim 9, wherein the coupling element includes at least two closed loops each encircling the at least one clamp and each extending through a respective portion of the net adjacent the loop.

12. The restraining device as defined in claim 11, wherein the at least one clamp includes at least two clamps, an outer clamp from the at least two clamps provided closer to a free end of the loop than an inner clamp from the at least two clamps slipping under smaller loads than the inner clamp.

13. The restraining device as defined in claim 1, further comprising a plurality of elongated cargo tie-downs each defining opposed proximal and distal ends, each cargo tie-down being secured to a respective one the attachments at its proximal end, and each cargo tie-down being securable to a respective one of the anchors at its distal end.

14. The restraining device as defined in claim 1, further comprising at least one reinforcement cable extending across the net between spaced apart locations on the peripheral cable.

15. A method of using the restraining device of claim 1, the method comprising:
fitting the net around a front portion of a cargo carried by a flatbed trailer or truck so that the peripheral cable is positioned around the cargo behind a frontwardmost portion of the cargo; and
securing the attachments to the anchors, the anchors being provided on the flatbed trailer or truck behind the net.

16. The method as defined in claim 15, wherein securing the attachments to the anchors includes providing cargo tie-downs between the attachments and the anchors.

17. The methods as defined in claim 16, further comprising applying a tension in the cargo tie-downs.

18. A method of using the restraining device of claim 1, the method comprising:
anchoring anchors in a wall or ceiling of a mine
fitting the net adjacent the wall or ceiling; and
securing the attachments to the anchors.

19. The method as defined in claim 18, wherein the net is secured to the ceiling of the mine.
